(19) United States
(12) Patent Application Publication
(10) Pub. No.: US 2013/0159111 A1
(43) Pub. Date: Jun. 20, 2013

(54) CUSTOMIZING BROWSING CONTENT BASED ON USER DATA INFERRED FROM TARGETED ADVERTISEMENTS

(71) Applicants: Adrian X. Rodriguez, Durham, NC (US); Eric Woods, Durham, NC (US)

(72) Inventors: Adrian X. Rodriguez, Durham, NC (US); Eric Woods, Durham, NC (US)

(73) Assignee: INTERNATIONAL BUSINESS MACHINES CORPORATION, Armonk, NY (US)

(21) Appl. No.: 13/326,467

(22) Filed: Dec. 15, 2011

(51) Int. Cl. G06Q 30/02

(52) U.S. Cl. 705/14.66

(57) ABSTRACT

A system comprising a web server containing website content, where the web server is configured for receiving requests from IP addresses for the website content and delivering the requested website content from the web server to the requesting IP address. The system further comprises an inspector tool that is configured for inspecting an advertising feed targeted to a first IP address and inferring user data from the advertising feed, and also a supplemental content generator configured for generating supplemental content according to the user data inferred from the advertising feed and providing the supplemental content to the first IP address.

### BACKGROUND

1. Field of the Invention

The present invention relates to capturing user data during user interaction with a website.

2. Background of the Related Art

The Internet is a global system of computer networks, including private, public, academic, business, and government networks, interconnected using the standard Internet protocol suite (TCP/IP) to serve billions of users worldwide. This network of networks is linked by a broad array of electronic, wireless, and optical networking technologies. Routers and other devices can move information packets across networks from a source to a destination device connected anywhere on the Internet. A user may access the Internet using any of a variety of different devices such as a laptop or desktop personal computer (“PC”), a tablet computer, or a smartphone, on any of the wired, wireless, and mobile connections currently available. The Internet carries a vast range of information resources and services, such as electronic mail (e-mail), telephone services, digital streaming home media content, and the World Wide Web (“Web”).

The World Wide Web comprises a vast system of websites containing interlinked hypertext documents accessible over the Internet. A website (i.e. “site”) is a collection of related web pages hosted on one or more web server, accessible via the Internet through an Internet address known as a Uniform Resource Locator (“URL”). A web browser is a software application used to view web pages and access website content. Some websites are commercially operated by online retailers who sell products and services through their websites. Other commercially operated websites generate profits by promoting the products and services of others, such as the online retailers. Even websites that are not run for profit will often generate significant operating income by advertising the products and services of other, commercially operated websites.

Internet marketing, also known as web marketing, online marketing, and e-marketing, involves the promotion of products and services over the Internet. Many methods have been developed for acquiring user data that can be used to provide targeted advertising to web users. Some online entities, such as Internet search engines, are focused heavily on capturing user data for marketing purposes. This user data is valuable and requires significant investment to obtain, so online entities who acquire this user data carefully safeguard it from being freely used by others. However, an entity can profit from the user data it has acquired without directly disclosing the data. For example, a web-based e-mail provider can obtain keywords from the content of a user's e-mail or from the user's search queries for selecting targeted advertisements to display to that user, without directly disclosing any of the profile data about the user to the advertiser. With each online entity collecting its own user data and maintaining that user data it in its own proprietary way, effort is duplicated among many entities. Entities who seek to acquire user data for marketing purposes must either capture the user data themselves, or pay for the use of user data obtained by others.

### BRIEF SUMMARY

A computer-implemented method is disclosed for automatically inferring user data from an advertising feed to a browser of the user and generating customized content to be displayed to the user based on the inferred user data. A request is received from a first user at a first IP address for content hosted on a web server. The requested content is delivered from the web server to the first IP address. An advertising feed targeted to the first IP address is inspected. User data is inferred from the advertising feed. Supplemental content is generated or selected according to the inferred user data. The supplemental content is provided to the first IP address. Computer usable program code for performing the method may be embodied on a computer usable storage medium.

A system is also disclosed for automatically inferring user data from an advertising feed and generating customized content based on the inferred user data. The system includes a web server containing website content. The web server is configured for receiving requests from IP addresses for the website content and delivering the requested website content from the web server to the requesting IP address over the Internet. An inspector tool accessible by the web server is configured for inspecting an advertising feed targeted to a first IP address and inferring user data from the advertising feed. A supplemental content generator, which may be controlled by the web server or another entity, is configured for generating or selecting supplemental content according to the content of the user data inferred from the advertising feed. The supplemental content, such as an additional advertising feed or a customized web content, theme or layout, is provided to the first IP address.

### BRIEF DESCRIPTION OF THE SEVERAL VIEWS OF THE DRAWINGS

FIG. 1 is a schematic diagram of a system for inferring user data from an advertising feed and customizing web content provided to a user based on the inferred user data.

FIG. 2 is a schematic diagram of the system of FIG. 1, wherein activity relating to a second user having an existing user profile is used as a reference in the process of inferring the user data about the first user.

FIG. 3 is a flowchart of a method in accordance with one embodiment of the present invention.

### DETAILED DESCRIPTION

Systems and methods are disclosed for inferring user data based on a third-party advertising feed provided to a user while browsing a website hosted by a web server. The user may be a new visitor to the website, having no appreciable recorded history on this particular website. The third-party advertising feed is based on user data previously obtained by another entity, such as an online retailer, social networking site, or Internet search engine. However, the previously obtained user data is not made directly available to the web server hosting the website that the user is now browsing. Without having direct access to that previously obtained user data, the web server obtains its own, inferred user data by analyzing the advertising feed that was generated from the previously obtained user data. The current website may then provide additional, customized content to the user based on the inferred user data, still without having direct access to the previously obtained user data that is the basis for the advertising feed. The customized content may include, for example, a separate, parallel advertising feed, selected web content, or a custom web interface (e.g. theme) based on the inferred user data.

Various ways of utilizing the third-party advertising feed to infer user data are described below. For example, the web server may identify and analyze the URL of a targeted advertisement (“ad”) or keywords found in the targeted ad, to infer user parameters such as demographics or interests. The analysis optionally includes comparing the ad content provided to a new user to ad content provided to another user with an established user profile on the current website. On the basis of this comparison, similarities between ads provided to both the new user and to the established user may be used to infer common user parameters between the two users, such as shared demographics or interests. In one embodiment, an advertisement URL history is stored for one or more additional users having known, established user profiles. An advertisement URL subsequently directed to the first user through the advertising feed is subsequently used as an index to the URL history to identify which of the one or more additional users also received the same advertisement. A user parameter common to the one or more additional users is then assigned to the first user.

The disclosed methods are useful not only for obtaining user data associated with a user before the user has an established history or profile on the website, but also to infer new user data about a user who may already have an established history or profile on the current website. For example, the user may have a prior history navigating the current website, or even an existing user profile that is available to the web server. Using the disclosed methods, additional, useful data that is not already part of the existing user data available to the web server can be inferred from the ad feed to supplement the existing user data.

As a simple example, a stream of ad content pertaining to automobile companies and auto dealerships directed to a user (the website visitor) may be used to infer that the user has an interest in automobiles or is possibly shopping for a new automobile, even though that information is not suggested by the user's previous history with this website. The web server may then generate customized web content, or select from among a large amount of available web content, according to this newly inferred user data, such as by automatically switching to a “new car” web page theme, or by feeding the inferred user data to the second ad server who may generate additional automobile-related ads. Furthermore, the web server may identify other users that received the same or similar ad content, and access their user profile to infer additional user data about the current user (the website visitor).

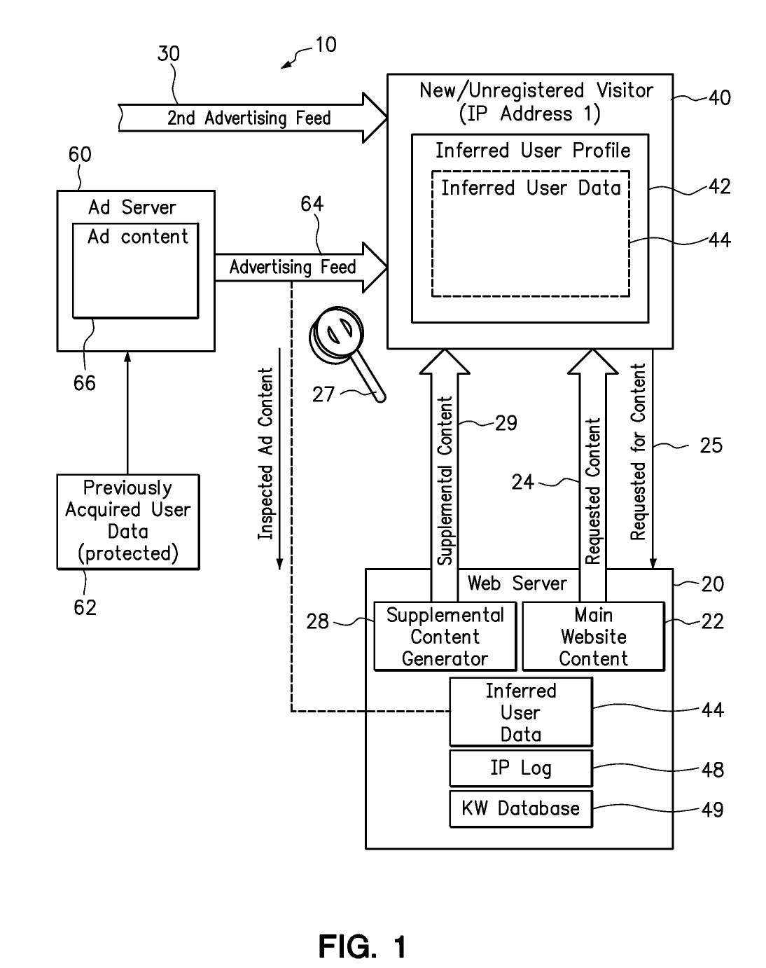

FIG. 1 is a schematic diagram of one embodiment of a system 10 for inferring user data from an advertising feed to a browser and selecting content to be displayed in the browser based on the inferred user data. A website (“site”) is provided on a web server 20, which may be owned and operated by a commercial website operator. The site includes website content (site content) 22, which may consist of any hypertext documents, images, video, or other digital assets. By way of example, the user 40 is assumed to be a “new” user having no appreciable history on this particular site available to the web server 20. The site may offer users the option of creating user profiles having associated preferences that can be used for marketing to the user. However, the user 40 is currently unregistered with the site, and has not provided any preferences.

The user 40 may view the site content 22 by issuing a request for content 25 from the user's browsing device (not shown). The browsing device has a unique IP address (IP Address 1) that can be used to identify this particular user, at least during a given session. A request for content may be as simple as the user entering the URL for the site in the web browser, in response to which the web server 20 returns the content of a web page at that URL. While on that URL, the user may click or otherwise select hyperlinks to content such as images, videos, and other web pages on that site. The requested content 24 is addressed to the IP Address 1 and is transmitted to the user's browsing device at IP Address 1. The site content 22 may be accessed and transported to IP Address 1 using the Hypertext Transfer Protocol (HTTP), or the encrypted HTTP Secure (HTTPS) protocol for added security and privacy. The user's web browser may render the website content 22 according to its hypertext markup language (HTML) instructions onto a display terminal (not shown). The user's current visit to the site may be logged on an IP log 48 of the web server 20, and in subsequent visits, the IP log may be consulted to identify accumulated information regarding the user 40.

While the user 40 may have no appreciable history with this particular site available to the web server 20, one or more third party has some previously acquired user data 62 about the user 40 that is used for marketing purposes. For example, the user 40 may have created a user profile on another site operated by an online retailer or a social networking site that has obtained marketing information from the user. The previously obtained user data may also have come from the user's activity on other sites, such as by placing small scripts known as tracking cookies on the user's computer. The user 40 may also use certain online e-mail and search engines that have access to e-mail and search content that could have been used to obtain the previously acquired user data 62. Any of this previously acquired user data 62 is assumed to be protected by those entities that acquired it, and is not made directly available to this web server 20. Here, this previously acquired user data 62 is used by a third-party ad server 60 to generate a third-party advertising feed 64 to the user 40. The advertising feed 64 may contain targeted ads delivered to the IP Address 1 and displayed along with the requested content 24. In a simple example, the requested content 24 may include a requested web page from the main website content 22 on the web server 20 to be displayed on a browser at IP Address 1, and the advertising feed 64 may include an embedded ad or a pop-up ad from the third-party ad server 60 to be displayed together with the requested web page.

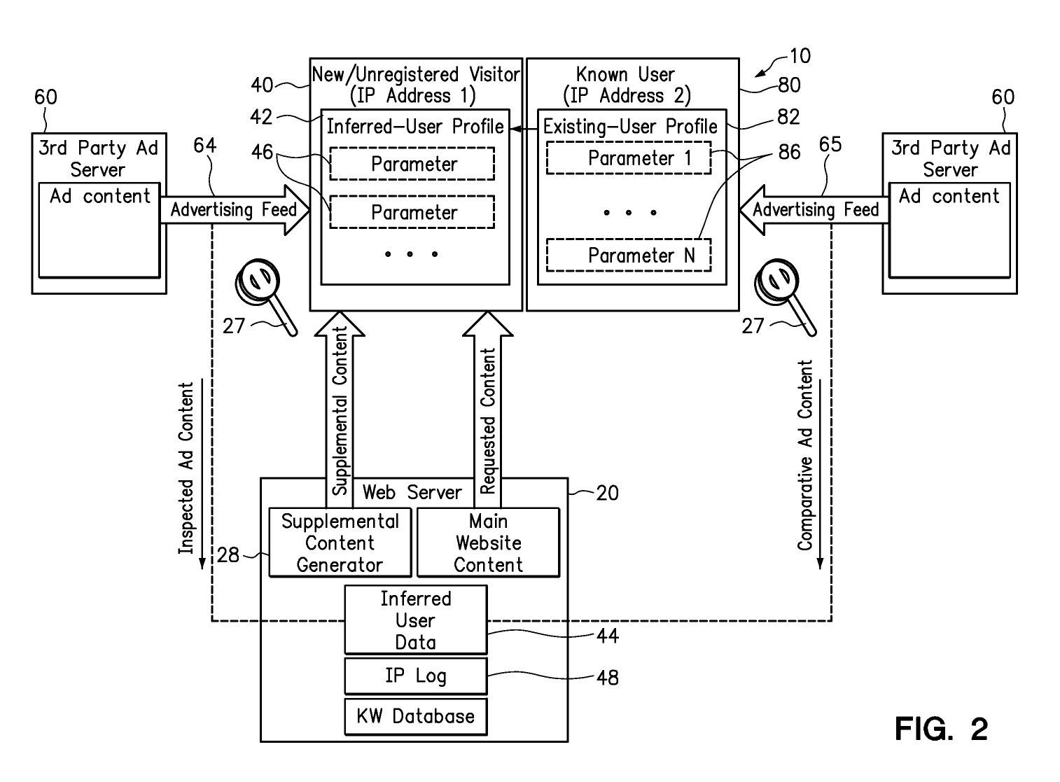

The web server 20 initiates an inspector tool 27 to inspect the advertising feed 64 generated by the ad server 60. The previously acquired user data 62 that forms the basis of the advertising feed 64 is not made available to the web server 20; rather, the web server 20 infers user data (i.e. the inferred user data 44) from the content of the advertising feed 64, itself. The inferred user data 44 may include one or more inferred user parameters that collectively form the basis of an inferred user profile 42. The inferred user data 44 may be used for any purpose to customize the web browsing experience of the user 40. It should be recognized that the block diagrams of FIGS. 1 and 2 are schematic in nature, and that the inferred user profile 42 and inferred user data 44 are preferably stored on or in association with the web server 20 and are preferably not stored on the web browser or other device of the user 40.

A supplemental content generator 28 generates supplemental content 29 based on the inferred user data 44. The supplemental content generator 28 may reside on the web server 20, as shown, or on another server. The supplemental content may take a variety of different forms. For example, the supplemental content 29 may be embodied as a second, parallel advertising feed 30. The parallel advertising feed 30 may be for the products or services offered by the operator of the web server 20. The inferred user data 44 could alternatively be sold to another third-party ad server for generating the second 30 advertising feed and delivered from a server other than the web server 20. An alternative example of the supplemental content 29 may be a customized web interface, such as a theme selected as a function of the inferred user data 44. Still further, the supplemental content 29 may be one or more targeted pages of the main website content 22.

The inspector tool 27 may utilize the advertising feed 64 in any of one or more ways in order to infer user data. In one implementation, for example, the advertising feed 64 may pass directly through the web server 20 en route to the user 40 at IP Address 1. The advertising feed 64 may pass through the web server 20, such as if the operator of the web server 20 and the third-party operator of the ad server 60 have an agreement for the ad content 66 to be displayed along with the main website content 22. Note that the advertising feed 64 is what passes through the web server 20, and not the previously acquired user data 62, which remains safeguarded by the third-party and is not made available to the web server 20. The ad content 66 may be inspected and parsed into inferred user data 44 at the web server 20 before, or separately from, the step of delivering the main website content 22 to the user's browser at IP Address 1. The ad content 66 may include an advertisement URL that the inspector component 27 could inspect. The web server 20 may then access the advertisement URL to ascertain the content at that advertisement URL. Alternatively, the ad content 66, itself, may include text or code that could be automatically read and understood by the inspector component 27 of the web server 20 in order to infer user data.

In some cases, the third-party ad server 60 may deliver the ad content 66 through an independent stream that does not pass through the web server 20 on its way to the user 40 at IP Address 1. However, the ad content 66 contained within the advertising feed 64 must still be delivered and rendered on the user's browser at IP Address 1. Once rendered on the user's browser, a browser script such as JavaScript may be used to scrape the advertisement URL of a particular advertisement and deliver the advertisement URL back to the web server 20 on a subsequent request for content 25. Once the web server 20 has the scraped URL, the web server 20 may fetch the actual advertisement content by following the URL, or the web server 20 may simply use the text of the URL to infer profile data.

An optional associative keyword database 49 contains a list of keywords with a list of user parameters, so that if the inspected ad content contains a certain keyword, a user parameter is assigned. For example, keywords relating to automobiles may be associated with a user interest in automobiles. If any of the keywords obtained from the inspected ad content are found in the keyword database, the inferred user data may include user parameters identified in the associative keyword database 49. Then, supplemental content such as website theme, website content or additional advertisements may be generated by the supplemental content generator 28 as a function of the inferred user parameters. Alternatively, the associative keyword database 49 may directly correlate the list of keywords with a list of supplemental content, such as website themes, website content or other advertisements. If any of the keywords in the associative keyword database 49 appear in the inspected ad content, the keywords can be used to generate the supplemental content taken directly from the associative keyword database 49.

In a simple example, the ad content 66 may include automobile-related ads. The ad content 66 may be inspected by the inspector component 27, whether that is done as the ad content 66 passes directly through the web server 20 en route to the user 40 or in a separate stream to the user 40. The inspection may reveal that the URL is to an automotive website. The URL or the ad content 66 at the URL may include text related to automobiles. The inferred user data 44 in this simplified example may include user parameters such as “interest=automotive” or “prospective automobile purchaser.” Additional clues may be used to refine these user parameters, either now or as a result of subsequent advertisements. For example, if the automotive ads are primarily related to dealership websites, the inferred user parameter may be “prospective automobile purchaser.” If the automotive ads are primarily related to automobile enthusiast websites, the inferred user parameter may be “interest=automotive.” The supplemental content 29 generated by the supplemental content generator 28 may include ads selected according to the inferred user data 44, such as automobile ads. The supplemental content 29 generated by the supplemental content generator 28 may also include an automobile-related browser theme.

FIG. 2 is a schematic diagram of the system 10 of FIG. 1, wherein activity relating to a known, second user 80 having an existing user profile 82 is used as a reference in the process of inferring the user data of the user 40 (referred to now as the “first user”) 40. The existing user profile 82 for the second user 80 includes user data that has previously been obtained about the second user 80, and which is already available to the web server 20. The existing user data may have been derived, for example, from a prior browsing history of the second user 80 on the web server 20. The existing user profile 82 may also include data which has been expressly provided by the second user 80 to the web server 20, such as profile data entered by the second user 80 when registering with the web server 20 and entering preferences. This known user data for the second user 80 has been compiled into a set of “N” user parameters 86. The user parameters 86 of the second user 80 may be embodied as electronically stored fields each representing some characteristic about the second user 82. An example of user parameters 86 include demographic information, such as gender, race, age, disabilities, mobility, home ownership, employment status, and even location. Other examples of user parameters 86 include interests and hobbies, recent or prospective purchases, political affiliation, group memberships, musical tastes, and other information particular to the user 82. Because the first user 40 is new to the website and has no appreciable user history on the web server 20, however, the first user 40 initially has blank fields for user parameters 46.

A second advertising feed 65 is targeted to the second user 80, which may be in parallel with the first advertising feed 64 to the first user 40. As diagrammed, the second advertising feed 65 comes from the same ad server 60 as the first advertising feed 64. However, it is possible for the two advertising feeds 64, 65 to instead come from different ad servers. The inspector tool 27 inspects both the “first” advertising feed 64 to the first user 40 and the “second” advertising feed 65 to the second user 80. The inspected ad content of the first advertising feed 64 may, itself, provide enough information to generate at least some of the inferred user data 44. However, inferred user data may also be obtained, supplemented, or confirmed by comparing the second advertising feed 65 to the first advertising feed 64 and identifying elements common to both advertising feeds 64, 65. For example, on the basis of similarities between the two advertising feeds 64, 65, one or more of the user parameters 86 already present in the second user's existing user profile 82 may be assigned to the user profile 42 of the first user 40. In one implementation, any of Parameter 1 to Parameter N may be copied to the previously empty fields of the first user profile 42.

By comparing the targeted ads that the first user 40 and the second user 80 and determining which of these ads the two users have in common, the web server 20 can infer information about the first user 40 that the web server 20 did not previously have based on the limited or non-existent browsing history of the first user 40 on the website. The observation that the first user 40 and the second user 80 have the same ads presented to them is a clue that the two users 40, 80 may have similar characteristics. Although the first user 40 is not registered with the website, the website can at least make an initial assumption or estimation that the second user 80 is similar to the first user 40. The supplemental content generator 28 may then customize or select the content provided to the first user 40, such as by presenting the first user 40 with additional advertisements (separate from the advertising feed 64) for similar products and services. The supplemental content generator 28 may also apply customized themes or other supplemental content to personalize the browsing experience of the first user 40.

In one basic example, the inspector tool 27 may identify an identical targeted ad being fed to both IP Address 1 and IP Address 2. For example, the ad targeted to both the first user 40 and the second user 80 may be from an automotive dealership or from a particular brand of automobile. The inspector tool 27 may then inspect the user parameters 86 in the second user profile 82 to confirm that at least one of the user parameters 86 is automobile-related. For example, the user parameter may be “interest=automotive,” or the user parameter may specify a preferred brand of automobile for the second user 80. On that basis, the user parameter may be copied from the second user profile 82 to the first user profile 42. While this approach of inferring user data may not be infallible in terms of the inferences made always being correct, the use of the second advertising feed 65 and the second user profile 82 provides additional information that can be used to increase the completeness, accuracy or reliability of the inferred user data 44.

In some cases, it may be difficult or impracticable to obtain useful user data directly from the characters in an advertisement URL or the contents of the advertisement URL. For example, the advertisement URL may not contain any useful keywords. Furthermore, the content located at the advertisement URL may have a format, such as a JPEG (Joint Photographic Experts Group) or Macromedia Flash, that is difficult to analyze for extracting user data. Another embodiment that is particularly useful in that situation is to store a history of the advertisement URLs received by the second user 80 and the advertisement URLs received by any number of additional users having known, existing user profile 82. The advertisement URLs subsequently received by the first user 40 may then be used as an index to look up the other users having established user profiles who have received the same advertising URL. The first user 40 may be assumed to have one or more user parameters in common with each of the established users who have received the same advertisement URL.

The established users who received the same advertising URL may have more than one user parameter in common, which leaves some uncertainty as to which user parameter(s) these users have in common. The degree of certainty as to which user parameters these users have in common may be increased by increasing the number of users involved in the comparison. For example, a targeted ad may be common to the first user 40, the second user 80, and a third user. The second and third user may have two or more user parameters in common, which leaves some uncertainty as to which of those two or more user parameters are also common to the first user 40. Extending the analysis to a fourth user having received the same advertising URL may, for example, reveal that only one user parameter is common to the second, third and fourth users. This could provide near certainty that the user parameter common to the second, third, and fourth users is a user parameter that is also common to the first user 40, assuming the advertisement URL had been presented to each of these users based solely on a specific user parameter. Thus, one or more additional user parameter may be inferred based on a comparison between first and third users that would not otherwise be inferred based on a comparison between the first user 40 and second user 80, alone.

Another useful aspect is that the first user 40 may choose to browse the website anonymously or at least semi-privately. This is a mutually advantageous trade-off between the first user 40 and the proprietor of the website, whereby the web server 20 may still infer user data that is useful for providing customized content to the first user 40, while the first user 40 maintains a desired level of privacy. For example, the first user 40 may limit or restrict cookies, and in particular, may limit or restrict third-party cookies. The first user 40 may also choose to browse in a “privacy mode” currently available on many browsers. Whereas web browsers normally store information such as browsing history, images, videos, and text within a cache, a privacy mode can prevent the browser from storing this information for selected browsing sessions. This allows the user 40 to browse the site without storing local data that could be retrieved at a later date. It is still possible to log visits to the website according to the IP address in the IP log 48, so that the web server 20 may associate the inferred user data 44 with IP Address 1.

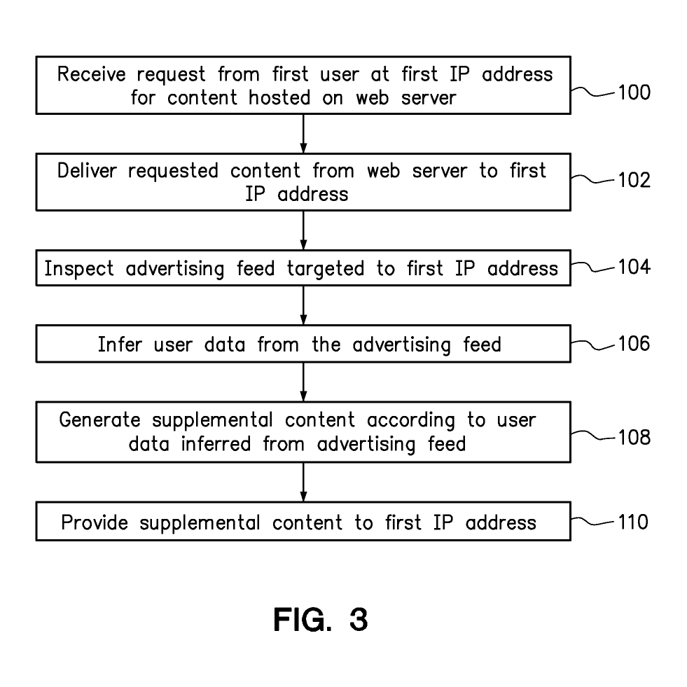

FIG. 3 is a flowchart generally outlining a method embodiment. In step 100, a request is received from a first user at a first IP address for content hosted on a web server. This request for content may be a routine aspect of browsing a website hosted on the web server. Typically, when browsing a website, the browser will specify a particular URL, which is returned by the web server as a web page at that URL. Within that web page, hyperlinks may be embedded to other content hosted on the web server, such as to other pages of the website or to multimedia linked by the web page. In response to the request, step 102 entails delivering the requested content from the web server to the first IP address.

In step 104, an advertising feed targeted to the first IP address is monitored or inspected. The advertising feed may be inspected by obtaining the URL of an advertisement contained within the advertising feed. The advertisement URL points to ad content hosted on an ad server. The web server may access the ad content located at the advertisement URL, and inspect the ad content, such as by identifying text or coding keywords. The web server may even obtain keywords from the URL itself.

Step 106 involves inferring user data from the advertising feed inspected in step 104. The inferred user data may include the keywords optionally obtained in step 104, for example. A keyword database may be consulted, correlating a list of keywords with a list of user parameters. For example, keywords relating to automobiles may be associated with a user interest in automobiles. If any of the keywords in the keyword database appear in the inspected ad content, the inferred user data may include user parameters identified in the keyword database. Then, supplemental content such as web theme or additional advertisements may be generated per step 108 as a function of the inferred user parameters. Alternatively, the keyword database may directly correlate the list of keywords with a list of supplemental content, such as web themes or other advertisements. If any of the keywords in the keyword database appear in the inspected ad content, the keywords can be used to generate the supplemental content taken directly from the keyword database in step 108.

Step 110 involves providing the supplemental content to the IP address. The supplemental content may be delivered directly from the web server to the IP address. For example, the web server may customize a theme or present additional ads to the user at the IP address.

Using the above system and methods, a website can correlate and gather information at a lower cost than with conventional methods of obtaining user data, such as by encouraging a user to register for the site or purchasing the user data of a particular user from a third-party source. This also enables the website to privately and securely leverage the information that a third-party has gathered without having to purchase or sign a contract with the third-party. These methods leverage the proprietary information that other, third-party advertisers and other entities have collected and uses it to build a narrower profile of anonymous users to their site.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1-7. (canceled)

8. A computer program product including computer usable program code embodied on a computer usable storage medium, the computer program product comprising:
computer usable program code for receiving a request from a first user at a first IP address for content hosted on a web server;
computer usable program code for delivering the requested content from the web server to the first IP address;
computer usable program code for inspecting an advertising feed targeted to the first IP address;
computer usable program code for inferring user data from the advertising feed;
computer usable program code for generating supplemental content according to the user data inferred from the advertising feed; and
computer usable program code for providing the supplemental content to the first IP address.

9. The computer program product of claim 8, further comprising:
computer usable program code for generating a temporary user profile associated with the user at the first IP address based on the inferred user data.

10. The computer program product of claim 8, further comprising:
computer usable program code for inspecting a separate advertising feed targeted to a second user having an available user profile;
computer usable program code for comparing the advertising feed to the second user to the advertising feed to the first user to determine elements common to both advertising feeds; and
computer usable program code for assigning one or more known user parameters of the second user to the inferred user data.

11. The computer program product of claim 8, further comprising:
computer usable program code for storing an advertisement Uniform Resource Locator (URL) history of one more additional users each having a known user profile;
computer usable program code for using an advertisement URL to the first user as an index to the advertisement URL history of the one or more additional users who have received the same advertisement URL;
computer usable program code for identifying a user parameter common to the one or more additional users who have received the same advertisement URL; and
computer usable program code for assigning the identified user parameter to the first user.

12. The computer program product of claim 8, wherein the computer usable program code for inferring user data from an advertising feed targeted to the first IP address comprises:
computer usable program code for identifying one or more words of text in the advertising feed; and
computer usable program code for assembling a user parameter comprising the one or more words.

13. The computer program product of claim 8, wherein the computer usable program code for inferring user data from an advertising feed targeted to the first IP address comprises:
computer usable program code for identifying an advertisement URL in the advertising feed;
computer usable program code for accessing the advertisement URL at the web server; and
computer usable program code for assembling a user parameter comprising the content of a page of the advertisement URL.

14. The computer program product of claim 8, wherein the computer usable program code for inferring the user data from the advertising feed comprises:
computer usable program code for rendering the advertising feed on a Web browser at the first IP address;
computer usable program code for using a script running at the first IP address to obtain a URL from the advertising feed; and
computer usable program code for sending the URL from the first IP address to the web server.

15. A system, comprising:
a web server containing website content, the web server configured for receiving requests from IP addresses for the website content and delivering the requested website content from the web server to the requesting IP address;
an inspector tool configured for inspecting an advertising feed targeted to a first IP address and inferring user data from the advertising feed; and
a supplemental content generator configured for generating supplemental content according to the user data inferred from the advertising feed and providing the supplemental content to the first IP address.

16. The system of claim 15, further comprising:
a profile generator configured for generating a temporary user profile associated with the first IP address based on the inferred user data.

17. The system of claim 15, wherein the inspector tool is further configured for inspecting a separate advertising feed targeted to a second IP address associated with a known user profile, comparing the advertising feed delivered to the second IP address to the advertising feed to the first IP address to determine elements common to both advertising feeds, and assigning one or more known user parameters of the second IP address to the inferred user data.

18. The system of claim 15, wherein the inspector tool is configured for identifying one or more words of text in the advertising feed and assembling a user parameter comprising the one or more words.

19. The system of claim 15, wherein the inspector tool is configured for identifying an advertisement Uniform Resource Locator (URL) in the advertising feed, accessing the advertisement URL at the web server, and assembling a user parameter comprising the content of a page of the advertisement URL.

20. The system of claim 15, further comprising:
a web browser at the first IP address containing a script to obtain a URL from the advertising feed and examining the URL or its contents to identify keywords for generating the user data.
